(19) United States
(12) Patent Application Publication
(10) Pub. No.: US 2018/0108090 A1
(43) Pub. Date: Apr. 19, 2018

(54) Lifetime Income Shares

(71) Applicant: Brian Walters, Windham, NH (US)

(72) Inventor: Brian Walters, Windham, NH (US)

(21) Appl. No.: 15/297,009

(22) Filed: Oct. 18, 2016

(51) Int. Cl. G06Q 40/06

(52) U.S. Cl. CPC G06Q 40/06

(57) ABSTRACT

Among other things to provide exchanged based lifetime income stream by packaging annuities and other guaranteed payments into a pooled fund to be sold and traded as exchange based funds. Two approaches are planned, one with a closed pool of representative annuitants the other with an open pool of actual annuitants. The closed pool will determine the optimal weights of Male/Female and Unisex investments and the appropriate timing to rebalance to the actual annuitants as well as cash management and threshold for capital raises. The open pool will calculate the threshold for capital raises, cash management. Secondary market will supply liquidity through a process of qualifying the investor's health to allow for exchange in the secondary market. A machine based microprocessor with proprietary algorithm will adjust for different aged investors and contract features in the same fund. Exchanges will be through either existing exchanges or a web based bid/ask exchange. Funds can be a combination of single aged participants or multi-aged participants. Process will include the option to use multiple insurers to diversify pool and enhance positioning in marketplace and require the allocation of assets, risk, revenues. Tracking and sharing of information, underwriting, as well as other relevant functions.

### BACKGROUND

Interval funds are a form of a closed end mutual fund that are designed to hold securities similar to annuities for long periods of time with little turnover. The annuities can be valued similar to other debt instruments such as CD's or high yield bonds. There is precedent for interval funds to allow periodic capital raises such as monthly if required. An investor can purchase shares of the fund and receive income in the form of a dividend on a monthly or periodic basis. The income will be paid until the death of the investor. Structuring the annuity/guaranteed investment into a security allows for broader distribution and can more easily be sold without loads making it a better deal for the investor as well as the insurer. The additional benefit is that the investor can sell the income stream rights in a secondary market without impacting the insurer provided that the sale is in accordance with the terms of the security. The bid/ask spread should be very tight as there is no significant advantage to buying direct in the primary market. Advisors are required under the DOL fiduciary rule to act in the investors best interest, that requirement will help to keep spreads tight when there is little difference between buying in the primary vs secondary markets.

Typical concerns with annuities include, high distribution costs (loads), lack of liquidity, complexity to buy, complexity to understand, their perceived fit into a portfolio.

By wrapping in a security, liquidity is met by the secondary market with no impact to the rate paid or insurer underlying investments. The security fits into a portfolio like an ETF or index fund, and buying it is as easy as buying a mutual fund. Under the DOL rule advisors are required to act in the best interest of the investor which requires the advisor to understand and evaluate this security.

### SUMMARY

The funds can be structured as age and feature specific, such as all 68 year old unisex immediate fixed fund or a 50 year old J&S deferred fund exclusively. Alternatively a fund can mix gender and ages and annuity types provided that a microprocessor based algorithm is used to keep assets and liabilities balanced at the investor level, similar in concept to tranches or classes. Therefore in the secondary market a similar algorithm can be used between buyers and sellers of different ages or genders. Whereby a 65 year old could sell to a 75 year old and the 75 year old would get a higher payout based on their age and expected lifespan and likewise a younger investor would get a lower payout for the same dollar invested.

The portfolio can be structured in multiple ways (see drawing 1) an open system takes the actual demographic information of the investor when they buy shares of the fund, if the investor sells the shares in the secondary market the payout adjusts if the buyer is a different age than the seller and the demographic data is updated on the microprocessor. In either case the impact to the insurer is negligible as the actuarial risks remain in balance.

The annuity/guaranteed contracts are held and valued similar to other securities in a portfolio.

The adverse selection is controlled by the seller proving health and selling to a similar buyer or adjusting the payment to account for the demographic/product feature difference.

The portfolio is purchased through units or shares like other funds. Each share offers a floor return with the ability for higher returns if the annuity participates in the performance of the underlying assets or general account then each share earns a prorated distribution based on the value of their investment, and the terms they chose. Investor A buys 1,000 class A (single life shares) at $x per share. Investor B buys 1000 class B J&S at $Y per share. Each share pays Z % in dividends as their value is equalized through the different class pricing. If each share pays Z % and we know the actual liability then the price can be set such that Z % is appropriate for each class. Alternatively each class could simply be its own fund.

The underlying liabilities are backed by either the guarantor general account or the assets underlying the portfolio holding the annuities/guaranteed investments separate account or portfolio.

Should the investor choose to sell the annuity, they will need to undergo a health exam similar to buying life insurance. Provided that the investor is healthy the investor is free to sell the security in the secondary market. In the case of a J&S investor (joint and survivor) where only one person is alive or found to be healthy then the investor can sell to a single life (non J&S) investor or adjust the payout to reflect that the seller received the benefit from the one life of the J&S policy and the current payment is now viewed as being a single life annuity and would have to be further adjusted if the buyer were a two life liability. The seller after receiving a certificate giving them the approval to sell the shares can trade them through a conventional exchange or through a proprietary web based exchange designed to specifically create a market for these securities.

A closed system is where the annuity portfolio is established based on proxy profiles of actual people. In this scenario the payouts are based on the proxy lives. The investor buys what is in essence a derivative investment and the assets and liabilities are managed via a microprocessor to balance out with minimal tracking error. The closed system holds the actual securities in a proxy portfolio that is managed against the liabilities in the investor portfolio. In this scenario the liabilities are packaged into tranches or classes which represent the different demographic and feature options of the annuities/guaranteed contracts held in the proxy fund. As proxy individuals die the reserves are released and the assets are released from the proxy fund. This may cause a slight temporary imbalance with the investor fund until an investor also dies in the investor pool releasing the liability. A large pool of investors will make any risk of mismatch very small. This temporary imbalance will be priced and managed by the manager of the fund such that all guaranteed liabilities will be met.

The sales in the secondary market for the closed fund happen in the same way as in the open fund.

### DESCRIPTION

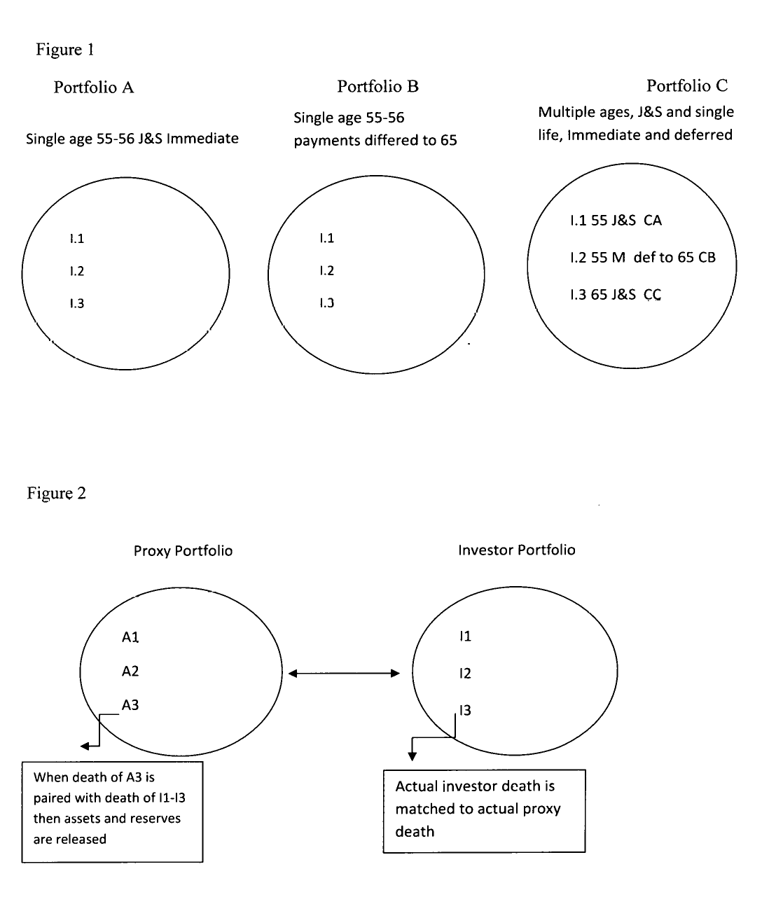

FIG. 1 Portfolio A is a schematic depiction of various options to structure a portfolio. Portfolio A is a single type of annuity contract each investor is the same age with the same unisex pricing and joint & survivor features. In this example if investor 1 or investor 2 wanted to sell the shares of their fund then they would prove health and receive a certificate and go to the secondary market to sell their shares. The new owner will get the same benefit provided that they are the same age. If they are younger they will get a lower payment and older they will get a higher payment all calculated on a proprietary microprocessor with computer readable storage device. The secondary market could be provided both by traditional exchanges as well as a proprietary web based exchange.

FIG. 1 Portfolio B is a schematic depiction of portfolio B which is similar to Portfolio A except the income payments are deferred for approximately 10 years in this example the price per share would be lower than someone investing the same amount of money in portfolio A because the money had a chance to be invested for 10 years prior to payment.

FIG. 1 Portfolio C depicts multiple types of contracts in one portfolio. Investor 1 is the same investor who was in portfolio A for this portfolio we will call that class A. Investor 2 is the same investor in portfolio B we will call that class B. Investor 3 is a 65 year J &S immediate investor that we will call class C. We could list multiple other classes A-Z. In each case each investor is receiving an annuity, some are deferred and some are Joint and survivor, some immediate. If we establish that the dividend for each share is based off an assumed $100 par value and each share is paid out at the same rate of x % when paid out, then we can adjust the actual price of each class such that each share class could have a unique price that is higher or lower than the par value. If the contracts are participating then the rate would be reflected as appropriate.

FIG. 2 is a schematic representation of a closed portfolio system. In this system the annuity is based on the lives of actual people however not necessarily the same people that is in the investment portfolio. The annuities are assets of the insurer and the revenues are used pay the liabilities of the investment pool this derivative structure allows the investor pool to receive the income and allows the investor to sell the rights to the income in the secondary market place without the annuity changing ownership. When the Proxy life A1-A3 dies the portfolio manager looks to the investor portfolio with the aid of a microprocessor driven algorithm to match the liabilities, in this example investor 13 with similar shares also dies during the month, at months ends both the proxy investor and actual investors are removed and reserves and assets are released.

Other embodiments are within scope of the claim.

What is claimed is:

1. Open Pool—A computer-implemented method comprising: receiving, by a microprocessor, profiles of annuitants characteristics, Genders, expected health and longevity. Through use of a microprocessor collect and store various actuarial and investor data to calculate weights of annuities and cash levels to balance portfolio and determine when capital raises are necessary.

2. Method of claim 1 wherein selecting genders is, Male, Female, Unisex.

3. Method of claim 1 wherein annuities/guarantees are immediate, income, deferred, Joint and Survivor or single life.

4. Method of claim 1 wherein annuities/guarantees with all factors including but not limited to those in claims 2-3 to aggregate and value to determine via microprocessor the need and timing to perform a capital raise or to balance portfolio or other management functions as needed for single or multiple insurers.

5. Method of claim 1 wherein rebalance threshold percentage is x %.

6. Method of claim 1 wherein rebalance threshold percentage is X dollars.

7. Closed pool of representative annuitants—A computer-implemented method of comprising, by microprocessor profiles of annuitant characteristics and constructing a portfolio on which guaranteed lifetime income is generated. The hypothetical annuitants are actual lives but may or may not be the actual lives receiving the income. Incremental profiles can be added at the time of capital raises. Closed pool is balanced against actual investors which are tradable on the secondary market. A computer implemented method is used to balance the closed pool with the actual investors and determining when capital raises are required.

8. Method of claim 7 wherein representative annuitant profiles are selected by micro-processor driven algorithm to create a pool of guaranteed annuitants who are tracked and are proxies for actual annuitants.

9. Method of claim 7 wherein representative annuitants are withdrawn from pool when they die.

10. Method of claim 7 wherein insurer is insulated from liquidating assets if the income stream is traded in secondary market.

11. Method of claim 7 wherein a microprocessor is used to balance the liabilities of the representative pool with the actual annuitants in derivative portfolio.

12. Method of claim 7 wherein microprocessors are used to withdraw actual annuitants from investor derivative portfolio when they die and the two pools are balanced.

13. Method of claim 7 wherein using a micro-processor to hedge the pools should lives be temporarily out of balance.

14. Method for qualifying income that the recipient is healthy and using a microprocessor to issue an electronic certificate via a computer readable storage device that allows income owner to sell future income stream to a third party.

15. Method for claim 14 wherein income recipient with valid certificate that allows exchange to enter proprietary webserver to exchange security and rights to income stream to a 3^{rd} party on a bid/ask basis.

16. Method for claim 14 wherein broker/advisor/individual can purchase rights to income stream on bid/ask basis.

17. Method for claim 14 wherein a microprocessor is used to calculate exchanges exchange rates for the secondary market for buyers and sellers of different ages and or genders.

18. Method for claim 14 wherein a microprocessor is used to transact buyer and seller information and complete transaction and receive confirmation of ownership records with insurer.

19. Method of combining multiple aged and gender annuitants with different annuity options into one fund comprised of multiple classes and using a microprocessor to value, price different classes account, manage, balance and track classes.

20. Method for claim 19 wherein micro-processor is used with a computer readable storage device to house and run an algorithm to aggregate assets and liabilities of multiple annuities into one portfolio.
